(19) United States
(12) Patent Application Publication
(10) Pub. No.: US 2015/0346962 A1
(43) Pub. Date: Dec. 3, 2015

(54) SYSTEM AND METHOD FOR TRACKING INTENSITY OF EXPRESSION ASSOCIATED WITH A SOCIAL FOLLOWER

(71) Applicant: Swaaag, Inc, Foster City, CA (US)

(72) Inventor: Tommaso DI BARTOLO, Foster City, CA (US)

(21) Appl. No.: 14/706,953

(22) Filed: May 7, 2015

Related U.S. Application Data
(60) Provisional application No. 61/990,092, filed on May 7, 2014.

(51) Int. Cl. G06F 3/0484; G06Q 10/06; H04L 29/08; H04L 29/06; H04L 12/58; G06Q 50/00; G06F 3/0486

(52) U.S. Cl. CPC G06F 3/04842; G06Q 50/01; G06Q 10/06; G06F 3/0486; H04L 65/403; H04L 51/32; H04L 67/22

(57) ABSTRACT

A computer-implemented method for facilitating social interactions is provided. The method comprises providing a user interface for viewing a post; providing a plurality of graphical elements within the user interface; wherein each graphical element is assigned as intensity from an intensity scale; allowing a user to select one of said graphical elements as a means of interacting with the post; and transmitting information the user's selection of the graphical element to a server.

This application claims the benefit of priority to U.S. Provisional Patent Application No. 61/990,092 filed May 7, 2014.

### BACKGROUND

Social media platforms have exploded in popularity in recent years. Examples of popular social media platforms include Facebook and Vine. Typically, such platforms allow a user/poster to post content in the form of text or video. The posted content is viewed by friends or followers (social followers), who may interact with the poster by “liking” the content through selection of a like button associated with the content.

One problem with “liking” content as described above is that all “likes” are treated equally and it is difficult to discern the true meaning of a like. For example, if a poster (the person who posts) were to post a video highlighting, say an incident of social injustice in the form of a policeman beating up someone then “liking” that video may have an unclear meaning. This is because it is not clear whether a follower is supportive of the police action or is sympathetic with the victim.

Moreover, even if all likes were taken to mean the same thing, the “liking’ of content as described does not capture the intensity of a follower's liking.

### SUMMARY

According to one aspect of the invention, a computer-implemented method for facilitating social interactions is provided.

The method comprises providing a user interface for viewing a post; providing a plurality of graphical elements within the user interface; wherein each graphical element is assigned as intensity from an intensity scale; allowing a user to select one of said graphical elements as a means of interacting with the post; and transmitting information the user's selection of the graphical element to a server.

Other aspects of the invention will be apparent from the detailed description below.

### BRIEF DESCRIPTION OF THE FIGURES

FIG. 1 shows how a like button may be partitioned into a series of graphical elements or like buttons, in accordance with one embodiment of the invention.

FIG. 2. Illustrated how each like button may represent a gift from the follower/fan to the poster/celebrity and has a credit cost associated with it, in accordance with one embodiment of the invention.

FIGS. 3-4 illustrate operations of a record button, in accordance with one embodiment.

FIGS. 5A and 5B illustrate scrolling of a social media feed with content magnetization, in accordance with one embodiment of the invention.

FIG. 6A-6B shows a like panel of a user interface (UI), in accordance with one embodiment.

FIG. 7 illustrates how a follower may reply to a post, in accordance with one embodiment.

FIGS. 8A-8B show aspects of a chat-style user interface, in accordance with one embodiment.

FIGS. 9A-9E show aspects of a dashboard, in accordance with one embodiment.

FIG. 10 shows an example of hardware 1000 that may be used to implement a server device accordance with one embodiment.

FIG. 11 shows an example of hardware 1000 that may be used to implement a server device accordance with one embodiment.

### DETAILED DESCRIPTION OF SOME EMBODIMENTS

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Broadly, embodiments of the present invention disclose a social media platform for sharing content. The platform is referred to herein as “selebrety”. In one embodiment, the platform may be used by a poster to capture a short video. In this respect, the platform is similar to Facebook or Vine.

In one embodiment, the posters may be celebrities or brands, whereas the followers are the fans of the celebrities or brands.

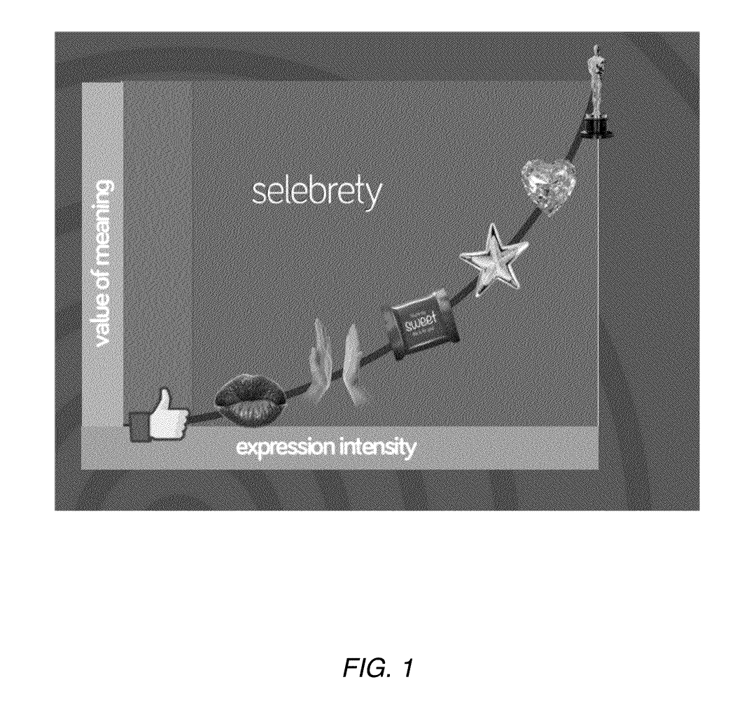

In one embodiment, a generic “like” button is divided or partitioned into a series of like buttons each indicative of an intensity of a fan's liking. Referring to FIG. 1 of the drawings, in one embodiment, the series of like buttons may represent a “kiss”, “applause”, “candy”, a “star”, a “diamond”, and an “Oscar” in order of increasing strength or intensity. Thus, for content that is “mildly liked” a fan may deem a “kiss” appropriate. However, for content that is “strongly liked” said fan may deem an “Oscar” appropriate. Thus, it can be seen how the type of like button used may be indicative of a fan's intensity of liking.

It is to be appreciated that the number of like buttons used to capture like intensity will vary on an implementation-by-implementation basis. Moreover, the names associated with the like buttons will be dependent on the nature of the poster-follower relationship. The examples provided above may be useful when the poster is an artist or celebrity and the follower is a fan.

In one embodiment, all likes are tracked and various metrics associated with the likes may be provided to a poster, e.g. in the form of a dashboard. In the case of the poster being a celebrity, the dashboard may be configured to show the celebrity's most ardent or loyal fans. For example, loyalty may be measured based on the strength or intensity associated with the like button used and how many time said like button was used.

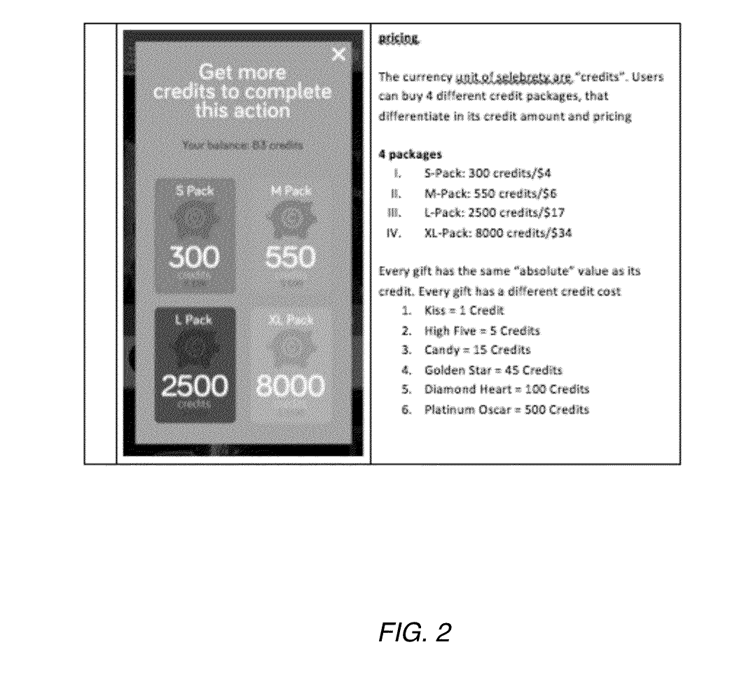

In one embodiment, likes may not be free and a user would be required to spend credits in order to send likes. Accordingly, in one embodiment the “selebrety platform” allows a follower to purchase credits in packs. Examples of packs are shown in FIG. 2. As can be seen, in one embodiment, an XL Pack has 8000 credits and costs $34. Each like button may represent a gift from the follower/fan to the poster/celebrity and has a credit cost associated with it as shown in FIG. 2. In the example of FIG. 2, a “kiss” like/gift costs 1 credit, whereas an “Oscar” like/gift costs 500 credits. A particularly strong signal of loyalty may be calculated in cases where a follower sends likes which cost the most credits multiple times.

In one embodiment, the selebrety platform may be configured to donate a portion of the proceeds from the sale of credits to a follower to a particular charity/foundation. The selebrety platform may allow the follower to select the charity/foundation. In a different embodiment, the selebrety platform may allow a poster in the form of a celebrity or brand to choose the charity/foundation.

One Click Capture

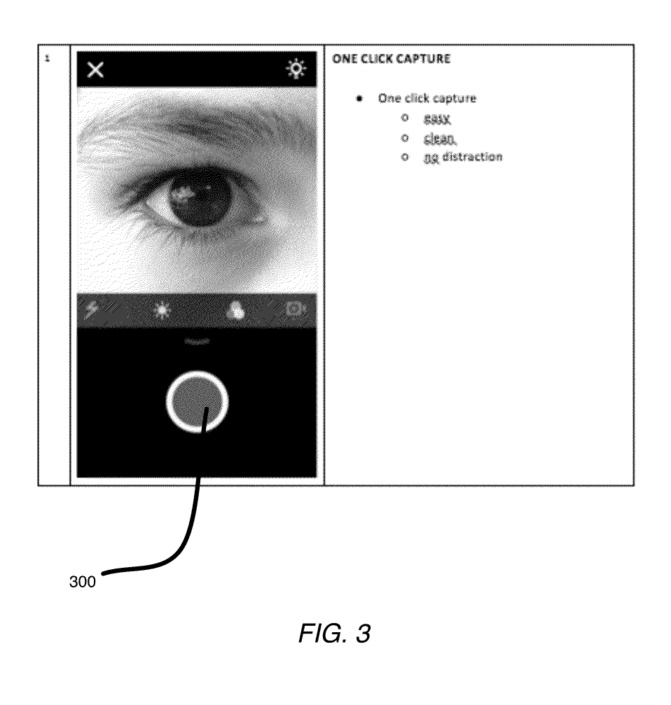

Embodiments of the present invention also disclose a client application configured to capture content, e.g. a short video, for sharing and liking as described. The client application may be configured to support one click capture wherein a video clip may be captured with a single click. FIG. 3 shows and example of a user interface with a record button 300 for facilitating single click video capture on a client device, in accordance with one embodiment.

Multiple Clip Capture

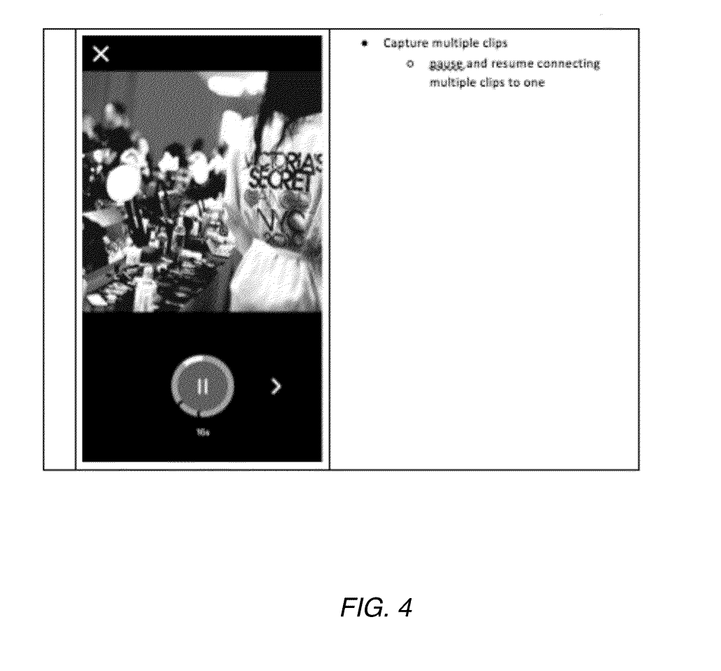

In one embodiment, the record button 300 may also be operated to pause and resume recording as shown in FIG. 4. Thus, multiple clips or recordings may be combined into a single video.

Feed Magnetization

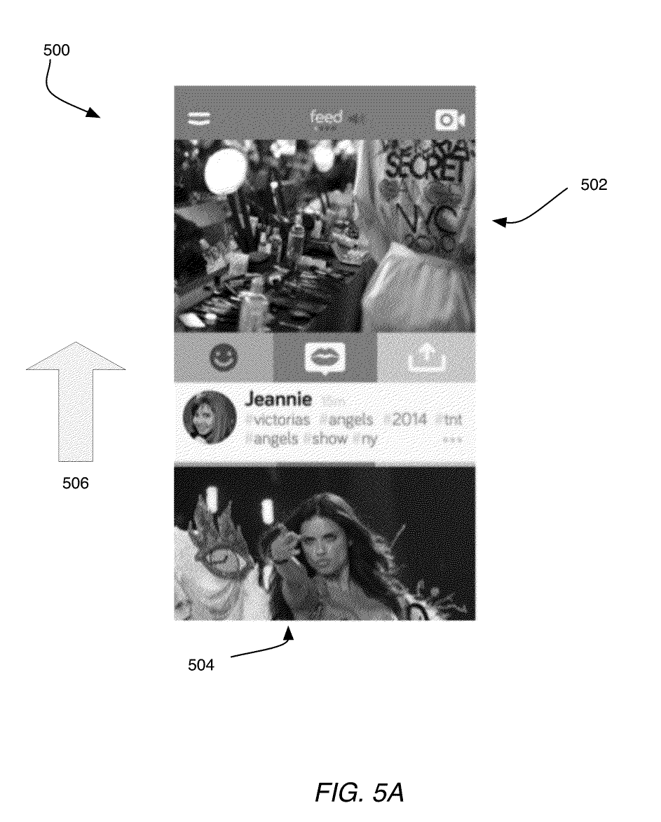

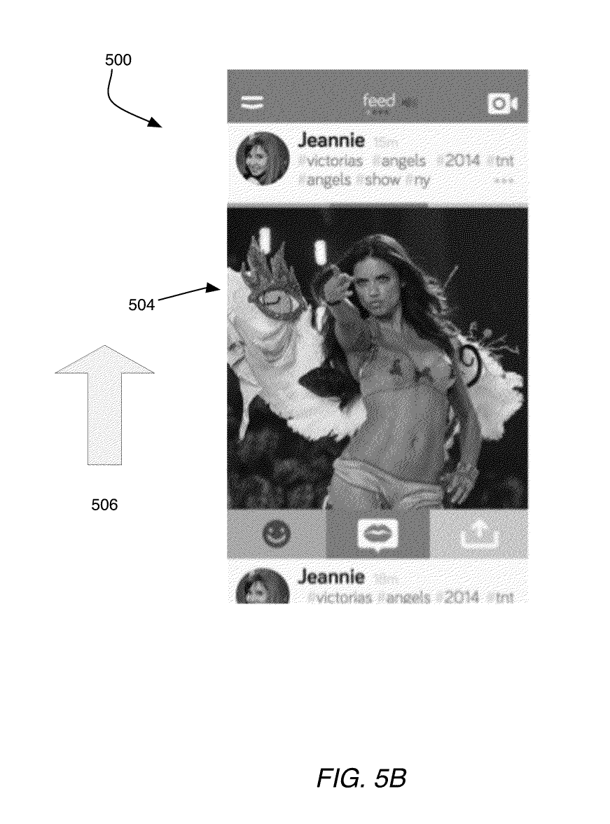

In one embodiment, the selebrety client application may be configured to support scrolling of a social media feed with content magnetization. This is illustrated in FIGS. 5A and 5B. Referring to FIG. 5A, reference numeral 500 generally indicates a social media feed. The feed 500 includes an upper image 502 and a lower image 504. Scrolling in the direction indicated by the arrow 506 has resulted in the lower image 504 having portions that are off-screen and that are thus not visible. In one embodiment, content magnetization allows content to be shown in its entirety when scrolling ends. With content magnetization, when scrolling, which may be initiated with a swipe, is about to end the following occurs:

(a) the velocity of the scroll slows down to eventually become zero; and

(b) the selebrety client application detects that scrolling is going to leave a portion of the lower image 504 off-screen. Responsive to this, the selebrety client app selects the lower image 504 for magnetization to the display of the device running the selebrety client app. The image selected for magnetization is fully displayed and no cut-off.

The result of scrolling with feed magnetization turned on is shown in FIG. 5B, where it can be seen that the lower image 504 having been magnetized to the display is fully visible.

In one embodiment, the feed magnetization feature may selectively turned on and off based on user preference.

In one embodiment, the feed magnetization feature may be configured to magnetize the upper image or the lower image based on which image is being shown the most on the screen when scrolling ends.

Drag and Drop Liking

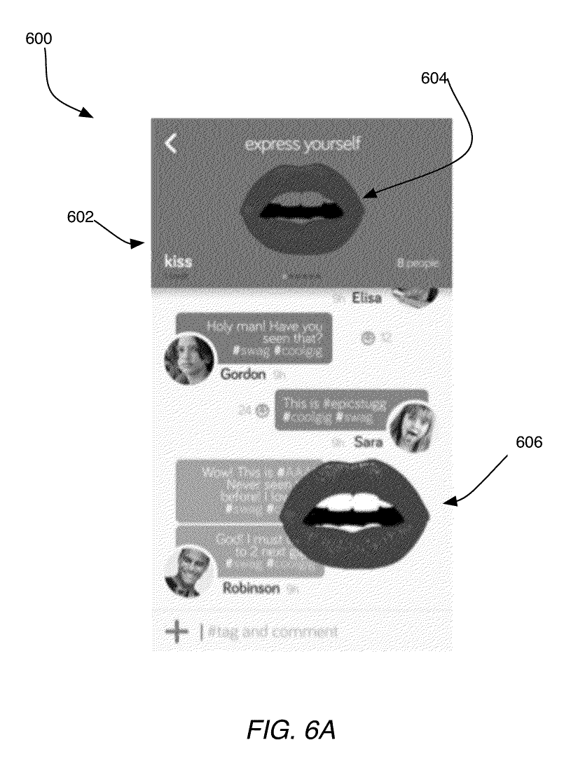

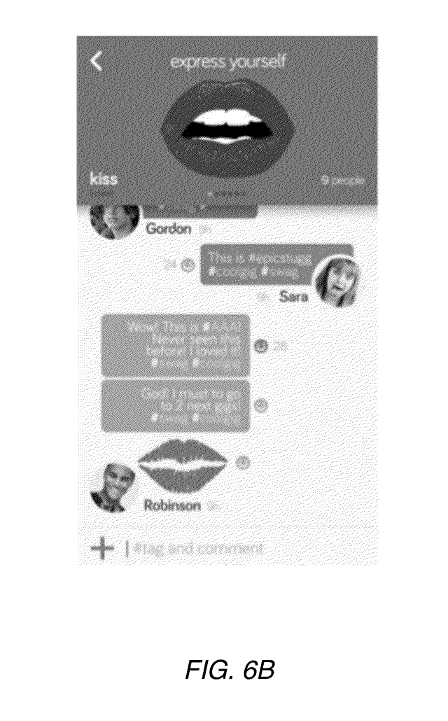

In one embodiment the likes are shown in a like panel 602 of a user interface (UI) associated with the selebrety client app, as is shown in FIG. 6A. In the particular case of FIG. 6A a like in the form of kiss 604 is shown in the panel 602. In one embodiment the panel 602 may be swiped to the left or right in order select other types of likes or virtual gifts. This is shown in FIG. 6B, where the panel 602 has been swiped to the left to select a “sweet” or candy as the like (virtual gift).

Referring again to FIG. 6A to send a “kiss” the fan drags the kiss from the panel 602 in a downward direction and releases it in the region 606. The result is a like in the form of a kiss sent by the fan as can be seen in FIG. 6B.

Video Reply

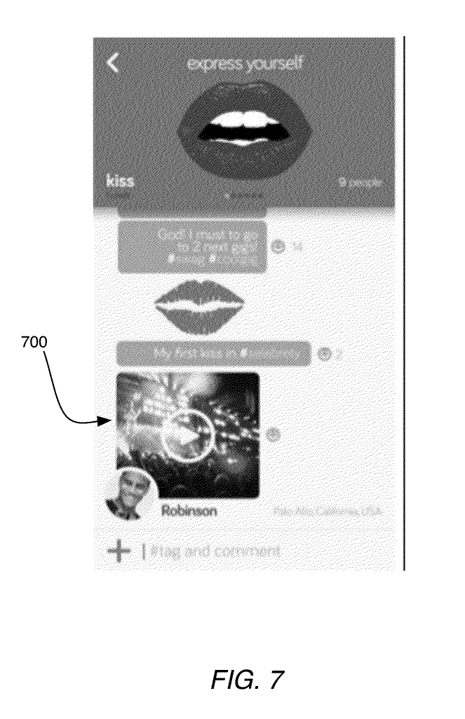

In one embodiment, the selebrety client app allows a follower to reply to a post by uploading a video. This is shown in FIG. 7, where the interface shows that the fan (Robinson, in this case) has posted a video 700 as a reply.

Chat-Style Interface in Social Video App

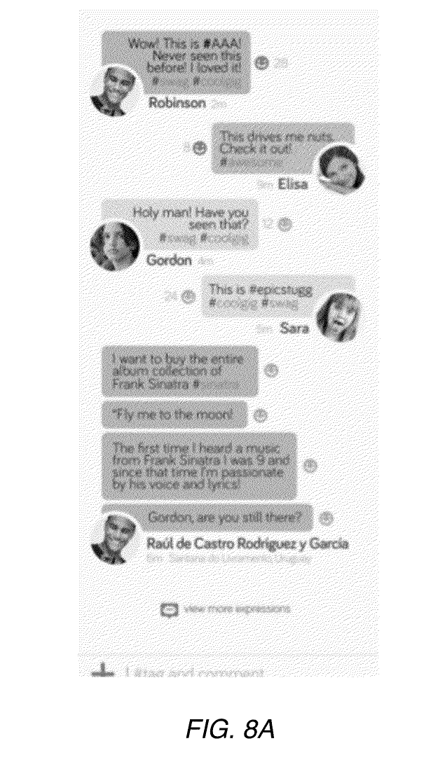

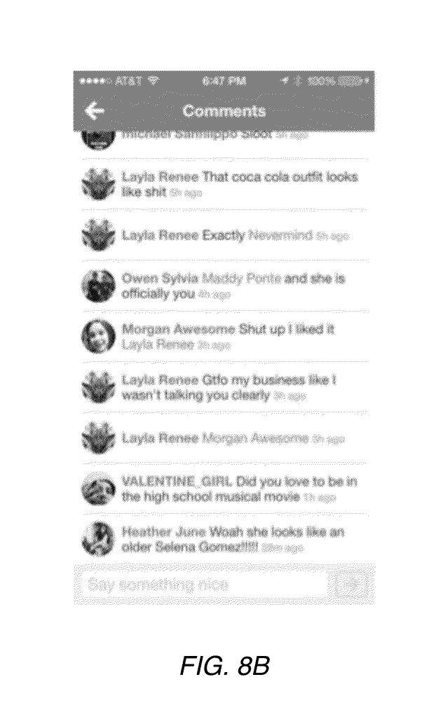

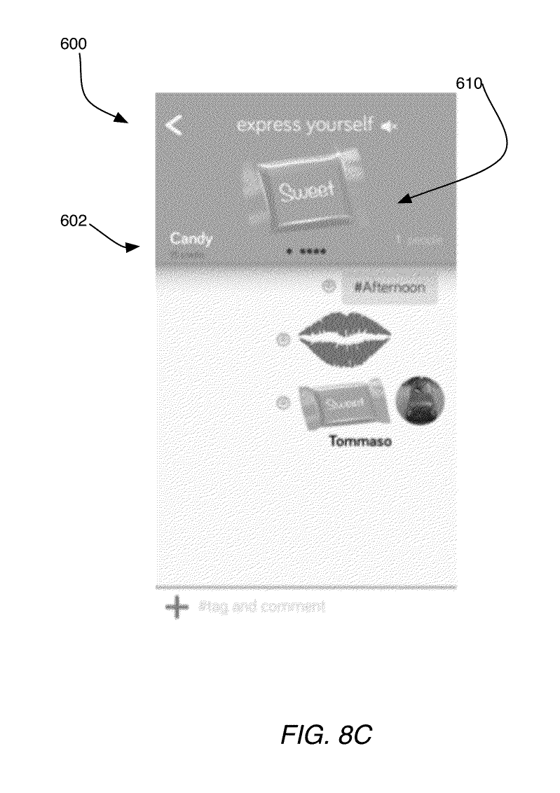

In one embodiment, the selebrety client app allows followers comment on a video post with a chat-style interface. This is shown in the UI example of FIG. 8A where it can be seen that comments/replies for a user are aligned to the left or the right edge of the screen in interleaved fashion. This is in contract to other interfaces that serially list comments/replies without left or right alignment, as is shown in the UI example of FIG. 8B.

Dashboards

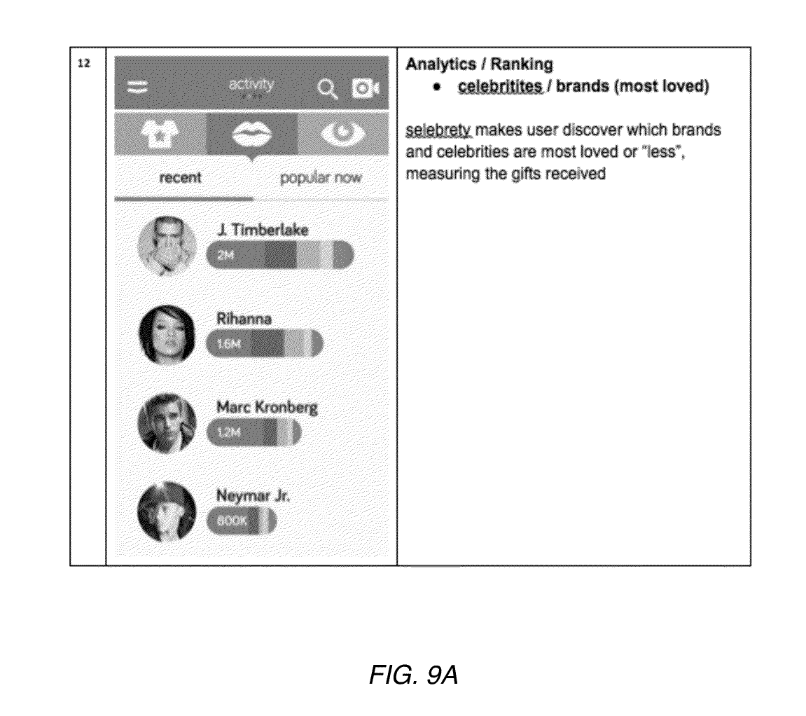

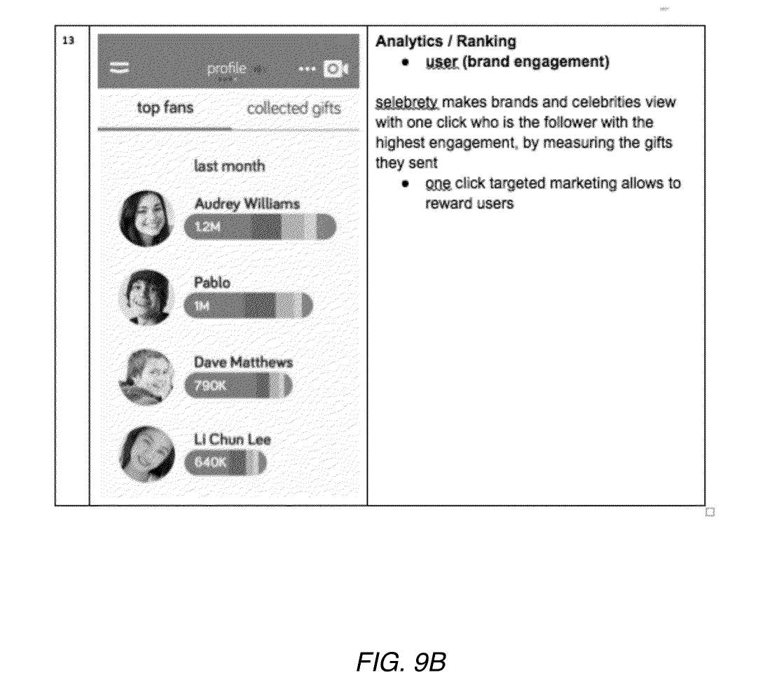

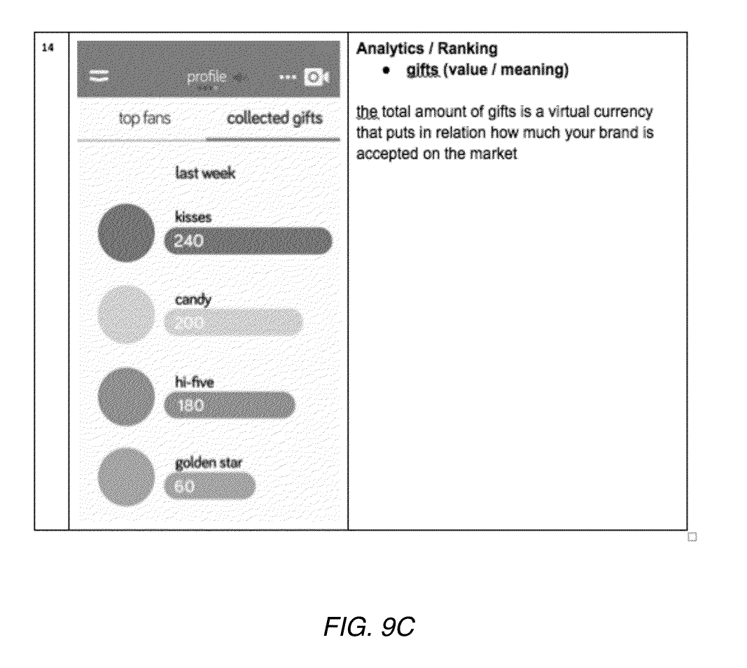

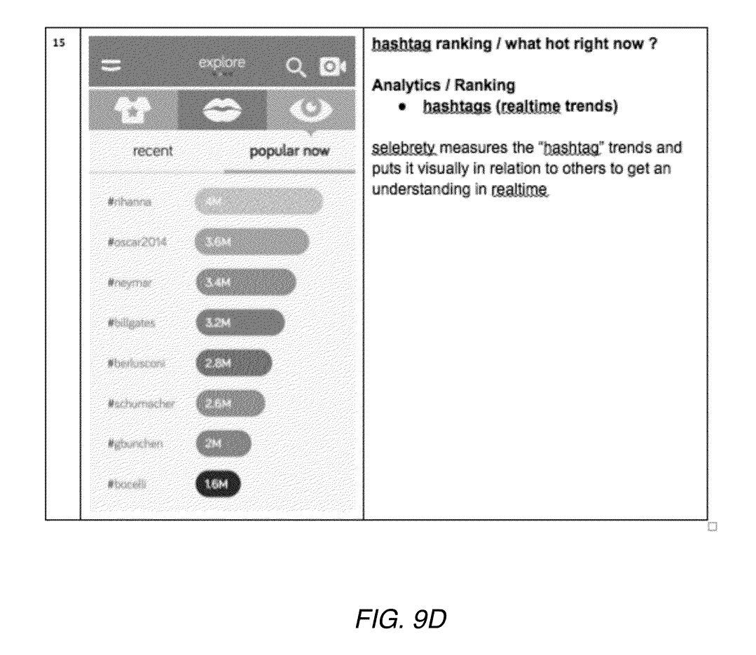

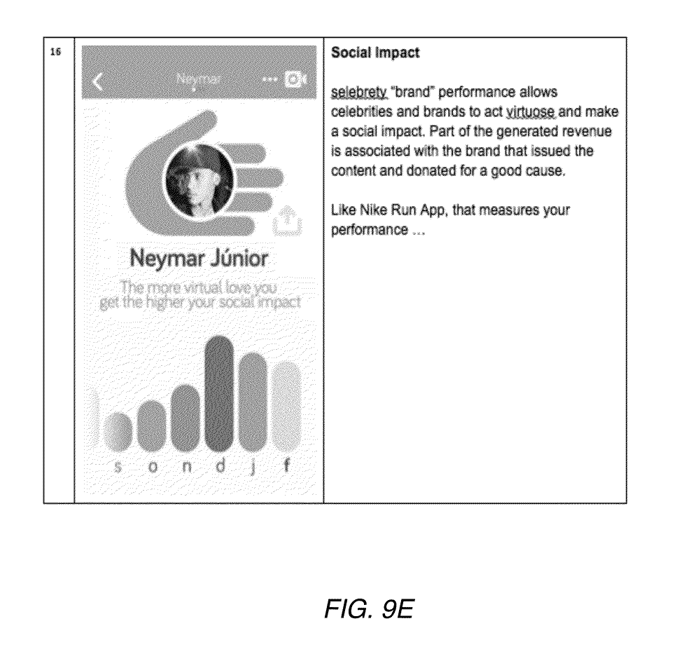

In one embodiment, an activity dashboard provides data on the brands/celebrities that are most popular. A UI for an activity dashboard is shown in FIG. 9A for tracking the popularity of brands/celebrities. For tracking followers, a dashboard such as is shown in FIG. 9B may be provided. In one embodiment, for tracking collected gifts from the perspective of a brand/celebrity, a dashboard such as is shown is FIG. 9C may be provided.

In one embodiment, tracking of hashtags may provide greater insight into a brand or celebrity's social impact. A dashboard for hashtag ranking is shown in FIG. 9D.

In one embodiment, a dashboard may also be provided to measure a brand or celebrity's impact over time as is shown in the example of FIG. 9E, where the impact of a celebrity's impact on a month-to-month basis is tracked.

The features/functions of the platform and client app described above may be implemented as modules. As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. After reading this description, it will become apparent to a person skilled in the relevant art how to implement the invention using other computing modules or architectures.

Modules might be implemented using a general-purpose or special-purpose processing engine such as, for example, a microprocessor, controller, or other control logic. In the illustrated example, the modules could be connected to a bus, although any communication medium can be used to facilitate interaction with other components of computing modules or to communicate externally.

A computing server might also include one or more memory modules, simply referred to herein as main memory. For example, preferably random access memory (RAM) or other dynamic memory, might be used for storing information and instructions to be executed by processor. Main memory might also be used for storing temporary variables or other intermediate information during execution of instructions to be executed by processor. Computing module might likewise include a read only memory (“ROM”) or other static storage device coupled to bus for storing static information and instructions for processor.

The database module might include, for example, a media drive and a storage unit interface. The media drive might include a drive or other mechanism to support fixed or removable storage media. For example, a hard disk drive, a floppy disk drive, a magnetic tape drive, an optical disk drive, a CD, DVD or Blu-ray drive (R or RW), or other removable or fixed media drive might be provided. Accordingly, storage media might include, for example, a hard disk, a floppy disk, magnetic tape, cartridge, optical disk, a CD, DVD or Blu-ray, or other fixed or removable medium that is read by, written to or accessed by media drive. As these examples illustrate, the storage media can include a computer usable storage medium having stored therein computer software or data.

In alternative embodiments, the database module might include other similar instrumentalities for allowing computer programs or other instructions or data to be loaded into computing module. Such instrumentalities might include, for example, a fixed or removable storage unit and an interface. Examples of such storage units and interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module.

The communications module might include various communications interfaces such as an Ethernet, network interface card, WiMedia, IEEE 802.XX or other interface), or other communications interface. Data transferred via communications interface might typically be carried on signals, which can be electronic, electromagnetic (which includes optical) or other signals capable of being exchanged by a given communications interface. These signals might be provided to communications interface via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

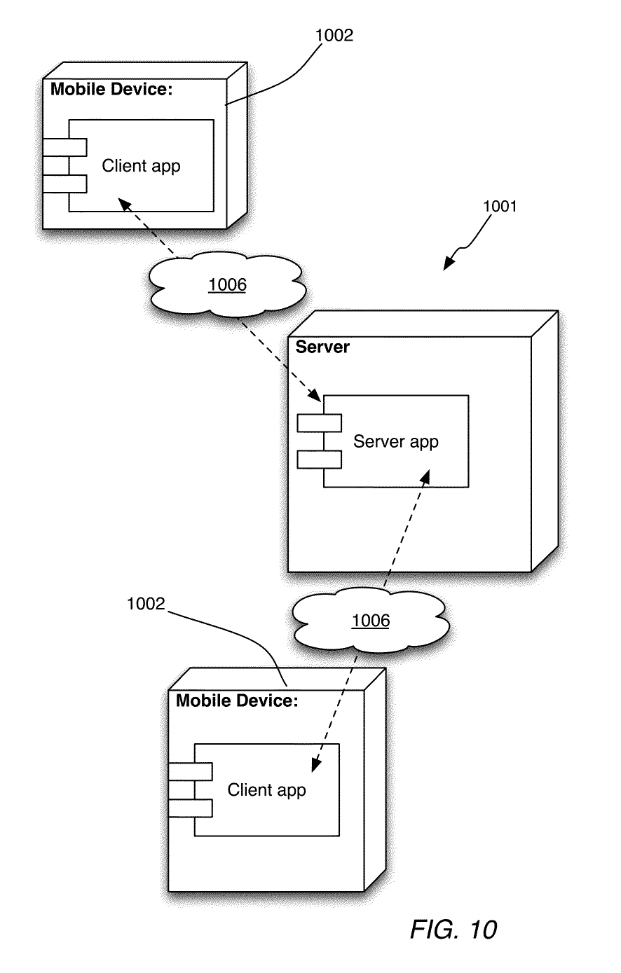

FIG. 10 shows a network configuration 1001 for practicing embodiments of the present invention. As will be seen, a plurality of mobile devices 1002 in the form of mobile phones are able to connect with a server device 1004 via wireless communications links 1006.

Wireless communications links 1006 may support any wireless protocol such as GMS and CDMA to enable cellular communications.

Server device 1004 comprises a transceiver 1016 and a memory 1018. The transceiver 1016 enables the sending and receiving of communications, whereas the memory 1018 stores instructions to enable the server device to operate and provide various functions.

The mobile devices are provisioned with a client app, and the server device is provisioned with a server app. Collectively, the client app and the server app cooperated to achieve the functionality described herein.

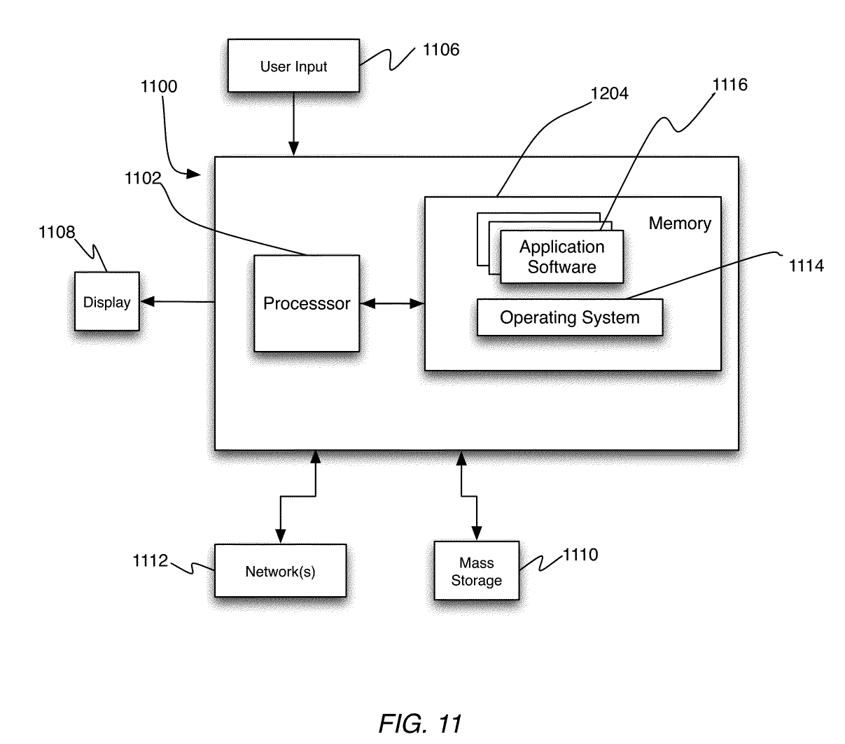

FIG. 11 shows an example of hardware 1100 that may be used to implement the server device 1004 in accordance with one embodiment. The hardware 1100 may includes at least one processor 1002 coupled to a memory 1004. The processor 1102 may represent one or more processors (e.g., microprocessors), and the memory 1104 may represent random access memory (RAM) devices comprising a main storage of the hardware, as well as any supplemental levels of memory e.g., cache memories, non-volatile or back-up memories (e.g. programmable or flash memories), read-only memories, etc. In addition, the memory 1104 may be considered to include memory storage physically located elsewhere in the hardware, e.g. any cache memory in the processor 1102, as well as any storage capacity used as a virtual memory, e.g., as stored on a mass storage device.

The hardware also typically receives a number of inputs and outputs for communicating information externally. For interface with a user or operator, the hardware may include one or more user input output devices 1106 (e.g., a keyboard, mouse, etc.) and a display 1108. For additional storage, the hardware 1100 may also include one or more mass storage devices 1110, e.g., a Universal Serial Bus (USB) or other removable disk drive, a hard disk drive, a Direct Access Storage Device (DASD), an optical drive (e.g. a Compact Disk (CD) drive, a Digital Versatile Disk (DVD) drive, etc.) and/or a USB drive, among others. Furthermore, the hardware may include an interface with one or more networks 1112 (e.g., a local area network (LAN), a wide area network (WAN), a wireless network, and/or the Internet among others) to permit the communication of information with other computers coupled to the networks. It should be appreciated that the hardware typically includes suitable analog and/or digital interfaces between the processor 1102 and each of the components, as is well known in the art.

The hardware 1100 operates under the control of an operating system 1114, and executes application software 1116 which includes various computer software applications, components, programs, objects, modules, etc. to perform the techniques described above.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

1. A computer-implemented method for facilitating social interactions, comprising:
providing a user interface for viewing a post;
providing a plurality of graphical elements within the user interface; wherein each graphical element is assigned as intensity from an intensity scale;
allowing a user to select one of said graphical elements as a means of interacting with the post; and
transmitting information the user's selection of the graphical element to a server.

2. The method of claim 1, wherein the intensity scale is configured to measure how much the user likes the post.

3. The method of claim 1, wherein allowing the user to select one of the graphical elements comprises allowing the user to make said selection by dragging the graphical element from the user interface onto the post.

4. The method of claim 1, wherein the post comprises video content.

5. The method of claim 1, further comprising assigning a point value to each graphical element.

6. The method of claim 1, further comprising tracking, by the server, all graphical elements assigned to said post across multiple users.

7. The method of claim 6, further comprising calculating a popularity score for the post by summing the points associated with the graphical elements assigned to said post by said multiple users.

8. The method of claim 1, wherein the graphical elements are selected from the group consisting of images bearing a likeness to “kiss”, “applause”, “candy”, a “star”, a “diamond”, and an “Oscar”.
